(19) United States
(12) Patent Application Publication
(10) Pub. No.: US 2026/0205991 A1
(43) Pub. Date: Jul. 16, 2026

(54) SYSTEMS AND METHODS FOR SIGNALING FOR SIDELINK POSITIONING ENHANCEMENT

(71) Applicant: ZTE CORPORATION, Shenzhen (CN)

(72) Inventors: Mengzhen LI, Shenzhen (CN); Chuangxin JIANG, Shenzhen (CN); Yu PAN, Shenzhen (CN); Focai PENG, Shenzhen (CN); Cong WANG, Shenzhen (CN); Junpeng LOU, Shenzhen (CN); Qi YANG, Shenzhen (CN)

(73) Assignee: ZTE CORPORATION, Shenzhen (CN)

(21) Appl. No.: 19/347,125

(22) Filed: Oct. 1, 2025

Related U.S. Application Data
(63) Continuation of application No. PCT/CN2023/087122, filed on Apr. 7, 2023.

(51) Int. Cl. H04W 64/00; H04W 72/25

(52) U.S. Cl. CPC H04W 64/00; H04W 72/25

(57) ABSTRACT

The present arrangement relates to systems, methods, and non-transitory computer-readable media for receiving a sidelink positioning reference signal (SL-PRS) configuration for a SL-PRS; determining a SL-PRS transmission parameter based on a congestion control parameter; transmitting the SL-PRS using inter-UE coordination (IUC) information; and measuring the SL-PRS within a measurement period.

### CROSS-REFERENCE TO RELATED APPLICATION

This application claims the benefit of priority under 35 U.S.C. § 120 as a continuation of International Patent Application No. PCT/CN2023/087122, filed on Apr. 7, 2023, the disclosure of which is incorporated herein by reference in its entirety.

### TECHNICAL FIELD

The disclosure relates generally to wireless communications and, more particularly, to sidelink communication.

### BACKGROUND

In 5th Generation Mobile Network System (5GC), sidelink is a key technology in new radio (NR) systems. Sidelink features may include positioning procedures to determine various aspects of sidelink communication, such as resource allocation, location, measurements, and reporting.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

In some arrangements, a sidelink positioning reference signal (SL-PRS) configuration may be received. A first wireless communication device may receive the SL-PRS configuration for a SL-PRS. The first wireless communication device may determine a SL-PRS transmission parameter based on a congestion control parameter. The first wireless communication device may transmit, to a second wireless communication device, the SL-PRS using inter-user equipment (UE) coordination (IUC) information, where the second wireless communication device may measure the SL-PRS within a measurement period.

In some arrangements, a SL-PRS may be received. A second wireless communication device may receive, from a first wireless communication device, the SL-PRS using IUC information. The second wireless communication device may measure the SL-PRS within a measurement period, where the first wireless communication device may receive SL-PRS configuration for the SL-PRS, and the first wireless communication device may determine an SL-PRS transmission parameter based on a congestion control parameter.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication system, according to some arrangements.

FIG. 2 illustrates block diagrams of an example base station and an example user equipment device, according to some arrangements.

FIG. 3 is a diagram illustrating an example sidelink configuration, according to various arrangements.

FIG. 4 is a diagram illustrating an example sidelink configuration, according to various arrangements.

FIG. 5 is a diagram illustrating an example sidelink configuration, according to various arrangements.

FIG. 6 is a diagram illustrating an example sidelink configuration, according to various arrangements.

FIG. 7 is a diagram illustrating an example sidelink configuration, according to various arrangements.

FIG. 8 is a diagram illustrating an example sidelink configuration, according to various arrangements.

FIG. 9 is a diagram illustrating an example sidelink configuration, according to various arrangements.

FIG. 10 is a diagram illustrating an example sidelink configuration, according to various arrangements.

FIG. 11 is a diagram illustrating an example sidelink configuration, according to some arrangements.

FIG. 12 is a diagram illustrating an example sidelink configuration, according to various arrangements.

FIG. 13 is a diagram illustrating an example wireless communication, according to various arrangements.

FIG. 14 is a diagram illustrating an example wireless communication, according to various arrangements.

FIG. 15 is a diagram illustrating an example wireless communication, according to various arrangements.

FIG. 16 is a diagram illustrating an example wireless communication, according to various arrangements.

FIG. 17 is a diagram illustrating an example wireless communication, according to various arrangements.

FIG. 18 is a diagram illustrating an example wireless communications system, according to various arrangements.

FIG. 19 is a flowchart diagram illustrating an example method for sidelink positioning enhancement, according to various arrangements.

FIG. 20 is a flowchart diagram illustrating an example method for sidelink positioning enhancement, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

In a wireless communications system supporting sidelink communication, a wireless device may communicate with another wireless device. As part of the sidelink communication process, the wireless communications system may support sidelink positioning reference signals (SL-PRSs), measurements and reports for sidelink (SL) positioning considering various positioning methods (e.g., round trip time (RTT), time difference of arrival (TDOA), angle-based positioning methods), and resource allocation for SL-PRS (considering both dedicated resource pool for SL-PRS and shared resource pool, both resource allocation scheme 1 and scheme 2). For SL communication, the time granularity is slot and the frequency granularity is sub-channel. SL-PRS resources and/or SL-PRS resource sets can be defined and used as resource allocation granularity. In some cases, the mechanism of SL-PRS sequence configuration, congestion control for SL positioning, and Inter-UE coordination (IUC), may be designed according to the granularities of resource allocation. The arrangement disclosed herein provides enhancements (e.g., additions, updates, changes) to signaling for sidelink positioning.

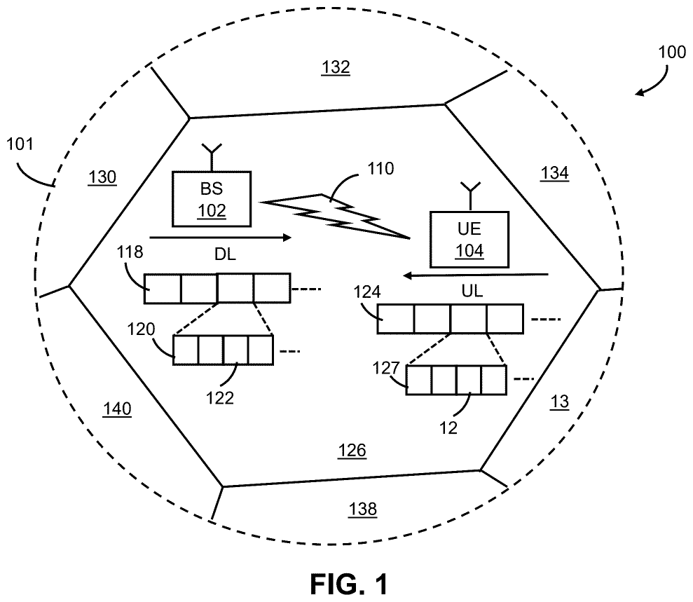

FIG. 1 illustrates an example wireless communication system 100 in which techniques disclosed herein may be implemented, in accordance with an implementation of the present disclosure. In the following discussion, the wireless communication system 100 can implement any wireless network, such as a cellular network or a narrowband Internet of things (NB-IoT) network, and is herein referred to as system 100. Such an example system 100 includes a BS 102 and a UE 104 that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one BS operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various implementations of the present solution.

In some implementations, the wireless communication system 100 may support MIMO communication. For example, MIMO is a key technology in new radio (NR) systems. MIMO may be functional in both frequency division duplex (FDD) and time division duplex (TDD) systems, among others. MIMO technologies may utilize reporting mechanisms such as CSI to support communication. CSI reports may include various types, parts, groups, and fields. The techniques described herein may provide enhancements to various aspects of the CSI report and reporting process. For example, a wireless communication device may receive, by a wireless communication device from a network, multiple reference signals and a configuration parameter. The wireless communication device may determine a CSI report based on the multiple reference signals and the configuration parameter, where the CSI report comprises CSI part 1 and CSI part 2. The wireless communication device may report, to the network, the CSI report. In some cases, the reporting process may include one or more of the following: the configuration parameter may be configured for enabling two or more CQIs in the CSI report, the reference signals are aperiodic or semi-persistent, and each of a CSI window length, DD basic unit size, an offset between two CSI reference signal (CSI-RS) resources, and a length of DD basic vector is larger than or equal to a threshold. Additionally, or alternatively, the wireless communication device may send, to the network, a User Equipment (UE) capability report indicating that the wireless communication device supports a number of CQI reports, where the number is a positive integer. The wireless communications system may implement codebooks to further support CSI reporting, among other various uses.

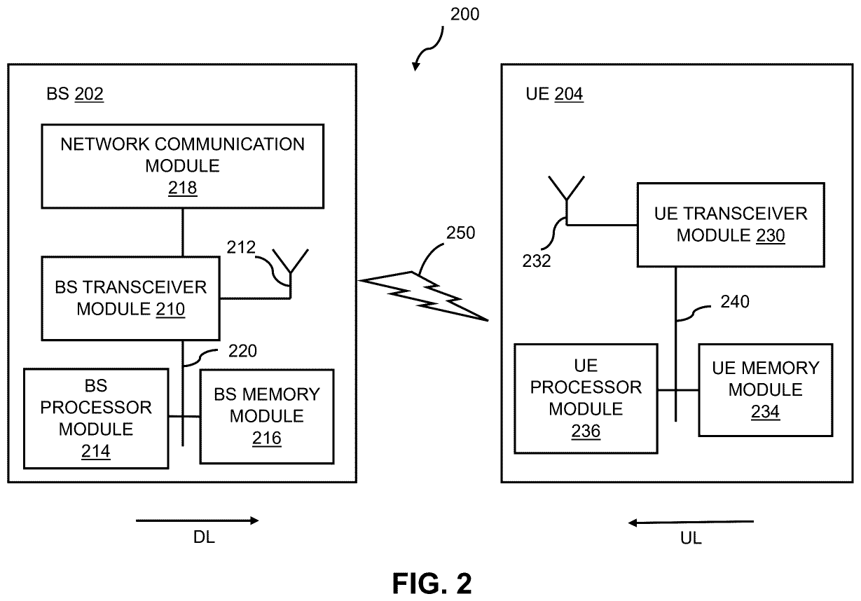

FIG. 2 illustrates a block diagram of an example wireless communication system 200 for transmitting and receiving wireless communication signals, e.g., OFDM/OFDMA signals, in accordance with some implementations of the present solution. The system 200 may include components and elements configured to support known or conventional operating features that need not be described in detail herein. In one illustrative implementation, system 200 can be used to communicate (e.g., transmit and receive) data symbols in a wireless communication environment such as the wireless communication environment 100 of FIG. 1, as described above.

System 200 generally includes a BS 202 and a UE 204. The BS 202 includes a Base Station (BS) transceiver module 210, a BS antenna 212, a BS processor module 214, a BS memory module 216, and a network communication module 218, each module being coupled and interconnected with one another as necessary via a data communication bus 220. The UE 204 includes a UE transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

The system 200 may further include any number of modules other than the modules shown in FIG. 2. Those skilled in the art will understand that the various illustrative blocks, modules, circuits, and processing logic described in connection with the implementations disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some implementations, the UE transceiver 230 may be referred to herein as an uplink transceiver 230 that includes a Radio Frequency (RF) transmitter and a RF receiver each including circuitry that is coupled to the antenna 232. A duplex switch (not shown) may alternatively couple the uplink transmitter or receiver to the uplink antenna in time duplex fashion. Similarly, in accordance with some implementations, the BS transceiver 210 may be referred to herein as a “downlink” transceiver 210 that includes a RF transmitter and a RF receiver each including circuitry that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some implementations, there is close time synchronization with a minimal guard time between changes in duplex direction.

The UE transceiver 230 and the BS transceiver 210 are configured to communicate via the wireless data communication link 250, and cooperate with a suitably configured RF antenna arrangement 212/232 that can support a particular wireless communication protocol and modulation scheme. In some illustrative implementations, the UE transceiver 210 and the BS transceiver 210 are configured to support industry standards such as the Long Term Evolution (LTE) and emerging 5G and 6G standards, and the like. It is understood, however, that the present disclosure is not necessarily limited in application to a particular standard and associated protocols. Rather, the UE transceiver 230 and the BS transceiver 210 may be configured to support alternate, or additional, wireless data communication protocols, including future standards or variations thereof.

In accordance with various implementations, the BS 202 may be an evolved node B (eNB), a serving eNB, a target eNB, a femto station, or a pico station, for example. In some implementations, the UE 204 can be various types of user devices such as a mobile phone, a smart phone, a Personal Digital Assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the methods described in connection with the implementations disclosed herein may be implemented directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some implementations, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the BS 202 that enable bi-directional communication between BS transceiver 210 and other network components and communication nodes configured to communication with the BS 202. For example, network communication module 218 may be configured to support internet or WiMAX traffic. In a typical deployment, without limitation, network communication module 218 provides an 802.3 Ethernet interface such that BS transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

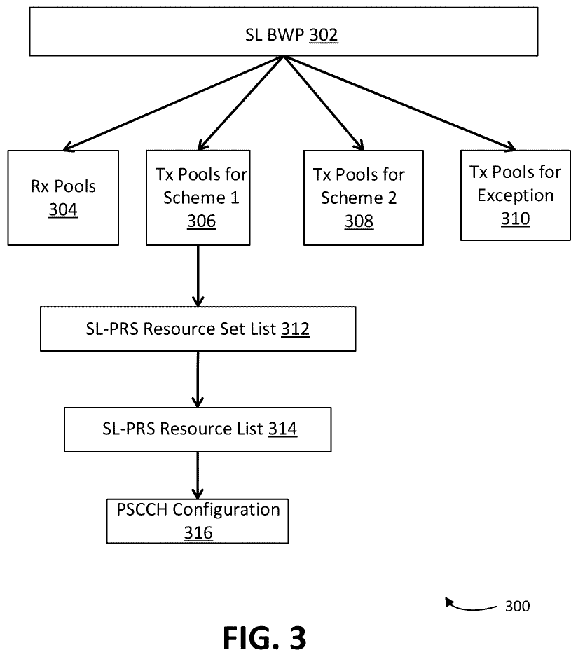

FIG. 3 is a diagram illustrating an example sidelink configuration 300, according to various arrangements. The sidelink configuration 300 may include an SL bandwidth part (BWP) 302, receive (Rx) pools 304, transmission (Tx) pools 306 for a first scheme (e.g., scheme 1), Tx pools 308 for a second scheme (e.g., scheme 2), Tx pools 310 for exceptions, an SL-PRS resource set list 312, an SL-PRS resource list 314, and a physical sidelink control channel (PSCCH) configuration 316.

Some wireless communication systems supporting sidelink may use PSCCH/physical sidelink shared channel (PSSCH). For PSCCH/PSSCH resource allocation in SL communication, time granularity may be slot based and a sub-channel may be defined as PSSCH frequency resource units, where the size of the sub-channel may be configured per resource pool. Both SL channel busy ratio (CBR) and SL channel occupancy ratio (CR), used for SL congestion control, may be defined based on a sub-channel busy indication or a sub-channel occupancy ratio. However, for SL positioning, SL-PRS allocation granularity may apply slot-based and sub-channel-based SL-PRS resource allocation, or sub-slot-based SL-PRS resource allocation, or SL-PRS-resource-based allocation. If a different resource allocation granularity from SL communication is applied, then the corresponding SL-PRS configurations/indications, including congestion control and IUC for SL-PRS, may be designed accordingly.

Support of sidelink positioning in NR systems may include at least three aspects: the design of SL-PRS; measurements and reporting for SL positioning considering various positioning methods (e.g. RTT, TDOA, angle-based positioning methods); and resource allocation for SL-PRS (e.g., considering both dedicated resource pool for SL-PRS and shared resource pool, both resource allocation scheme 1 and scheme 2). With regards to SL-PRS resource allocation, both scheme 1 (e.g., a network-centric operation SL-PRS resource allocation scheme) and scheme 2 (e.g., a UE autonomous SL-PRS resource allocation scheme) are introduced for supporting SL positioning/ranging.

In some cases, a wireless communication device may include a UE. The UE can be a vehicle UE, a pedestrian UE, a road-side unit (RSU), a positioning reference unit (PRU), or any UE that supports vehicle-to-everything (V2X) services and/or sidelink communication. A UE can be with or without a known position. For description purposes, an SL-PRS IUC may represent an inter-UE coordination for sidelink positioning.

In some embodiments, the sidelink configuration 300 may support SL-PRS configuration and resource indication. For example, a UE can be configured by higher layers with one or more resource pools for SL positioning. A resource pool for SL positioning (e.g., a SL-PRS resource pool) can be a dedicated resource pool for SL-PRS or a shared resource pool with SL communication. An SL-PRS resource pool can be for transmission of SL-PRS or for reception of SL-PRS and can be associated with either SL-PRS resource allocation scheme 1 or SL-PRS resource allocation scheme 2.

In the time and frequency domain, the SL-PRS resource pool can be interpreted as a set of time and frequency resources which can be used for SL-PRS transmission/reception. In some cases, the set of time and frequency resources can be used for the corresponding PSCCH/PSSCH/PSFCH transmission/reception. An SL-PRS resource pool configuration is preconfigured or configured by higher layers signaling from another UE (e.g., sidelink positioning protocol (SLPP)) or a location management function (LMF) (e.g., LTE positioning protocol (LPP)) or gNB via radio resource control (RRC) signaling. For example, the configuration may indicate that one bandwidth and one comb size are expected for all SL-PRS resources in one SL-PRS resource pool.

Different from SL communication, where the resource allocation time granularity for PSSCH is by slot and the frequency granularity of PSSCH is by sub-channel, SL-PRS is a reference signal and similar to other reference signals (e.g. downlink (DL)-PRS). The SL-PRS may be configured and allocated to a UE on an SL-PRS-resource basis. SL-PRS resources from different UEs can be multiplexed on a comb-based level or time division multiplex (TDM)-based level. For one SL-PRS resource pool, one or more of indicator(s) can be introduced. For example, the various indicators may include allowed/supported indicators that may include, comb-based multiplexing for SL-PRS resources from different UEs only; time division multiplexed (TDM)-based multiplexing for SL-PRS resources from different UEs only; a combination of comb-based multiplexing and TDM-based multiplexing for SL-PRS resources from different UEs; and/or configured indicators that may include, comb-based multiplexing for SL-PRS resources from different UEs only; TDM-based multiplexing for SL-PRS resources from different UEs only; and/or a combination of comb-based multiplexing and TDM-based multiplexing for SL-PRS resources from different UEs. The techniques disclosed herein may support SL-PRS configuration and SL-PRS resource allocation/indication.

In a first example, a higher layer aspect may be supported. Each SL-PRS resource pool may include one or multiple SL-PRS resource sets, where each SL-PRS resource set consists of one or multiple SL-PRS resources. In a SL-PRS resource pool, each SL-PRS resource or SL-PRS resource set may be associated with a PSCCH/sidelink control information (SCI) configuration (e.g., a configuration for a respective SCI for SL-PRS resources or resource sets). Each SL-PRS resource or SL-PRS resource set may be configured along with an identity (ID) (e.g., a SL-PRS resource ID, a SL-PRS resource set ID).

For example, as shown in FIG. 3, one or more SL-PRS resource pools are configured (pre-configured) within a SL BWP 302 of a carrier. Each UE can be configured with M Rx SL-PRS resource pools 304 (e.g., reception), N Tx SL-PRS resource pools 306 for scheme1 (e.g., transmission), N Tx SL-PRS resource pools 308 for scheme2, and L Tx SL-PRS resource pools 310 for exception. Each SL-PRS resource configuration may be associated with a PSCCH/SCI configuration 316. The configuration may include time resources of PSCCH/SCI and/or frequency resources of PSCCH/SCI (e.g., lists 312 and 314). The configurations may include a time gap between PSCCH/SCI and associated SL-PRS resources, a starting symbol, and a number of symbols of PSCCH/SCI.

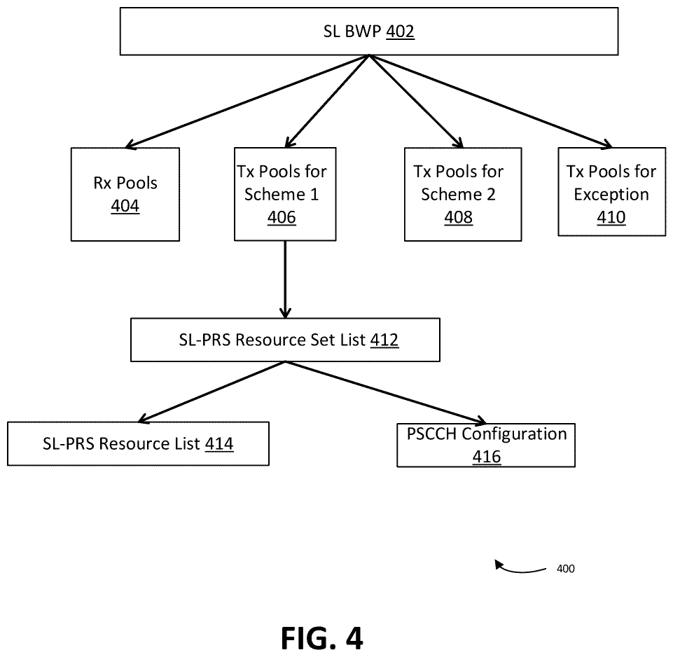

With reference to FIG. 4 (a diagram illustrating an example sidelink configuration 400, according to various arrangements), each SL-PRS resource set configuration may be associated with a PSCCH/SCI configuration 416. The configuration 416 may include indications for time resources of PSCCH/SCI and/or frequency resources of PSCCH/SCI. The configuration 416 may include the time gap between PSCCH/SCI and associated SL-PRS resource set, a starting symbol, and a number of symbols of PSCCH/SCI. FIG. 4 may include a SL BWP 402, a Rx Pools 404, Tx pools 406 for scheme 1, Tx pools 408 for scheme 2, Tx pools 410 for exceptions, an SL-PRS resource set list 412, an SL-PRS resource list 414, and a PSCCH configuration 416, similar to FIG. 3.

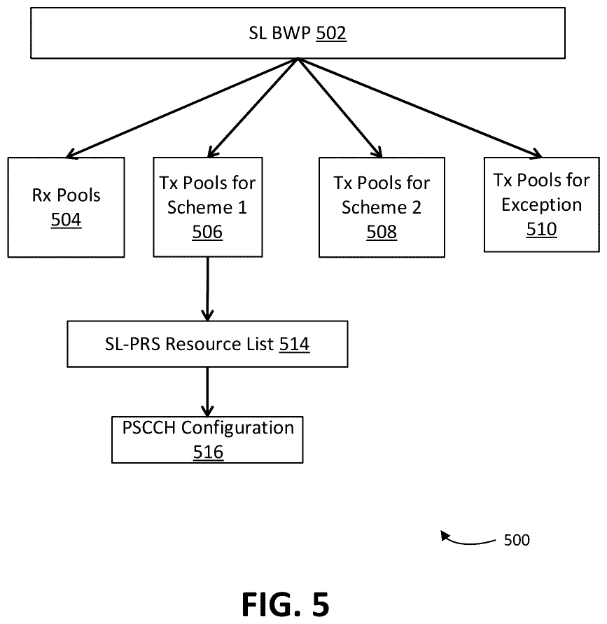

FIG. 5 is a diagram illustrating an example sidelink configuration 500, according to various arrangements. The sidelink configuration 500 may include an SL BWP 502, Rx pools 504, Tx pools 506 for scheme 1, Tx pools 508 for scheme 2, Tx pools 510 for exceptions, an SL-PRS resource list 514, and a PSCCH configuration 516.

In a second example, a higher layer aspect may be supported. Some beam related functions of SL may not be established yet and an SCI can be used to indicate a time domain configuration (e.g., time resource assignment, resource reservation period). In some cases, an SL-PRS resource set may not be introduced. For example, each SL-PRS resource pool may include one or multiple SL-PRS resources (e.g., list 514) without an SL-PRS resource set configuration. Each SL-PRS resource may be associated with a PSCCH configuration (e.g., a configuration for an SCI corresponding to respective SL-PRS resources).

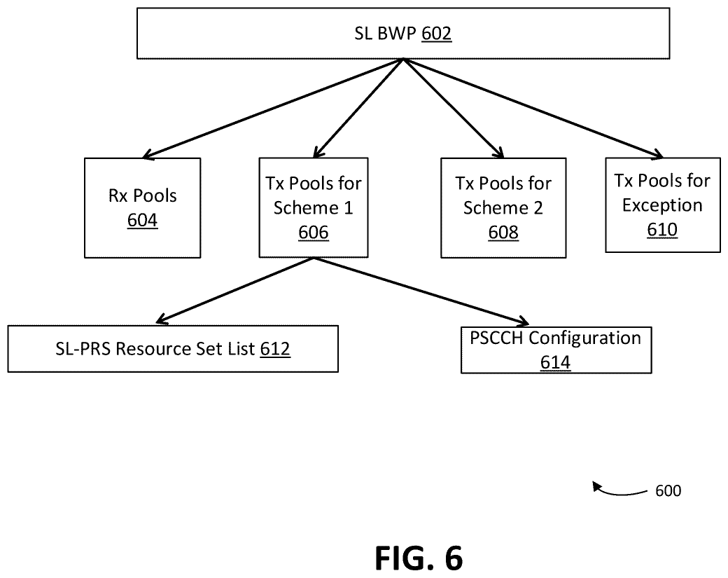

FIG. 6 is a diagram illustrating an example sidelink configuration 600, according to various arrangements. The sidelink configuration 600 may include an SL BWP 602, Rx pools 604, Tx pools 606 for scheme 1, Tx pools 608 for scheme 2, Tx pools 610 for exceptions, an SL-PRS resource set list 612, and a PSCCH configuration 614.

In a third example, a higher layer aspect may be supported. An SL-PRS resource pool may include a PSCCH configuration and an SL-PRS configuration, where an SL-PRS configuration (e.g., configuration 614) may include a list of SL-PRS resources or SL-PRS resource sets (e.g., list 612). For an SL-PRS configuration in a resource pool, the configuration may include a (minimum) time gap between an SL-PRS and an associated PSCCH, resource block (RB) set (e.g., a bandwidth of a resource pool can be different from the bandwidth of SL-RS), and/or SL-PRS period.

Each SL-PRS resource or resource set configuration can include one or more parameters. For example, the parameters may include a UE ID (e.g., indicating which UE uses the corresponding SL-PRS resource/resource set configuration), SL-PRS bandwidth, a comb size, an SL-PRS resource set ID, SL-PRS periodicity for periodic SL-PRS, a resource set level slot offset, an SL-PRS resource repetition factor, a time gap between two repeated instances of an SL-PRS resource, a number of symbols per SL-PRS resource within a slot, a muting option, an SL-PRS resource power, an SL-PRS resource ID, an SL-PRS sequence ID, both a comb size and an RE offset, an SL-PRS resource level slot offset, a symbol offset, SL-PRS QCL info, and/or an SL-PRS resource priority subset, SL PRS resource frequency location and bandwidth, SCS, resource type (e.g. periodic/semi-persistent/aperiodic SL PRS), priority (priority of SL PRS resource/SL PRS resource set or priority of SL-PRS transmission).

In some cases, SL-PRS assistance data can include SL-PRS resources configured for one or more UE(s). For example, in SL-TDOA, a UE or an LMF may indicate to a target UE information about an SL-PRS resource configuration of multiple anchor UEs.

In some examples, lower layer aspects may be supported. A resource pool configuration may be higher layer signaling and/or low layer signaling (e.g., SCI, SL medium access control (MAC) control element (CE)) and can be used for reserving/indicating one or more SL-PRS resource/configuration(s). One or more of the following can be supported: an SCI indicates one or more SL-PRS resource ID(s); an SCI indicates one or more SL-PRS resource set ID(s) (e.g., one SCI triggers/reserves/indicates a SL-PRS resource set which consists of multiple SL-PRS resources or one SCI triggers/reserves/indicates more than one SL-PRS resources); an SCI indicates the SL-PRS resource pool ID; an SCI indicates resource pool ID and SL-PRS resource ID; an SCI indicates SL-PRS resource set ID and SL-PRS resource pool ID; an SCI indicates resource pool ID and SL-PRS resource set ID and SL-PRS resource ID; an SCI indicates time resource assignment and frequency resource assignment of SL-PRS (e.g., a frequency range indicated in the SCI can be the same or smaller than the SL-PRS bandwidth configured in SL-PRS resource pool); and/or an SCI indicates comb size for SL-PRS, slot offset, symbol offset, number of symbols, frequency location, number of RBs, and periodicity of one or more SL-PRS resource(s). The SCI can be a single-stage SCI, or a first stage SCI, or a second stage SCI.

For an SCI indicating the SL-PRS resource pool ID, if an SL-PRS resource 1 in SL-PRS resource pool 1 is the same as an SL-PRS resource 3 in an SL-PRS resource pool 2, then if the SCI only indicates resource ID equal to 1, the Rx UE may have difficulty determining information configured for resource 1 without determining a resource pool ID. In some cases, when the SCI indicates an SL-PRS resource pool ID, different UEs may have a different understanding/interpretation for the same SL-PRS resource pool ID. To align the UEs' understanding, a UE or an LMF may provide multiple SL-PRS resource pool configurations per UE via SLPP or LPP signaling. The multiple UEs mentioned may be involved in one positioning session.

For an SL-PRS bandwidth configuration, at least one of the following options can be supported. A first option may be, the configuration of SL-PRS bandwidth may be indicated in SCI. For either a dedicated resource pool or a shared resource pool, the bandwidth can be same or smaller than that of the resource pool. (e.g., for a shared resource pool, the bandwidth is the same as that of PSSCH if they are transmitted in the same slot). A second option may be, the bandwidth of SL-PRS is up to pool level configuration (e.g., an SL-ResourcePool may include SL-PSSCH-config/SL-PSCCH-config/SL-PSFCH-config, and an SL-PRS-Config). The bandwidth of SL-PRS may be one of SL-PRS-Config and one or more parameters (e.g., SL-PRS priority, SL-PRS power control) may be included in the SL-PRS. A third option may be, the bandwidth of SL-PRS is up to both resource pool configuration and SCI indication (e.g., the common/intersection frequency resources). In such case, SCI may indicate a SL PRS resource ID where the SL PRS resource is configured in resource pool and bandwidth is still indicated in higher layer. In some cases, the following may contribute to SL-PRS bandwidth configuration flexibility: a) Similar as bandwidth of DL-PRS configured per positioning frequency layer (PFL), the bandwidth of SL-PRS can be configured per dedicated/shared resource pool. In other words, the bandwidth of SL-PRS is the same as that of the resource pool. A UE can be (pre-) configured with multiple resource pools to make sure it can transmit SL-PRS of various bandwidths. b) In order to increase configuration flexibility, the bandwidth of SL-PRS can be the same or smaller than that of a resource pool. For example, bandwidth is one of the parameters configured for each SL PRS resource. For shared resource pools, SL-PRS bandwidth can be indicated either in new second stage SCI (e.g., an SCI different from another SCI, like SCI 2-D) or reusing a second stage SCI. The new SCI or reused SCI can include an SL-PRS bandwidth or include the identification of an SL-PRS resource. If lower layers indicate SL-PRS bandwidth, then flexibility may increase for SL-PRS configurations.

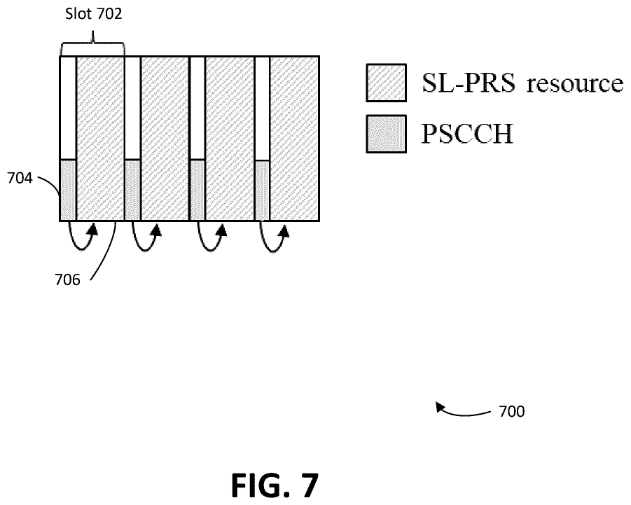

FIG. 7 is a diagram illustrating an example sidelink configuration 700, according to various arrangements. The configuration 700 may include a slot 702 that includes a resource 704 (e.g., SL-PRS resource) associated with a control channel 706 (e.g., PSCCH).

In some cases, an SL-PRS sequence may be supported. For example, a sequence of SL-PRS (e.g., pseudorandom-based) r (m) can be generated according to:

$$r ( m ) = \frac{1}{\sqrt{2}} ( 1 - 2 c ( 2 m ) ) + j \frac{1}{\sqrt{2}} ( 1 - 2 c ( 2 m + 1 ) )$$

Where c(i) is a pseudo-random sequence and its initialization function design Cinit is one of the key factors for SL-PRS sequence generation. The pseudo-random sequence c(i) for SL-PRS can be initialized according to:

$${c}_{init} = ( {2}^{m} ( {N}_{symb}^{slot} {n}_{s , f}^{μ} + l + 1 ) ( 2 {n}_{ID}^{SL - PRS} + 1 ) + {n}_{ID}^{S L - PRS} ) mod {2}^{31}$$

Adding a high-bit offset to align with DL-PRS's sequence design and enable the multiplexing between SL-PRS and SL CSI-RS may result in technical advantages. The pseudo-random sequence c(i) for SL-PRS may be initialized according to:

$$\begin{matrix}{c}_{init} = ( {2}^{22} ⌊ \frac{{n}_{ID}^{SL - PRS}}{1024} ⌋ + {2}^{10} ( {N}_{symb}^{slot} {n}_{s , f}^{μ} + l + 1 ) ( 2 ( {n}_{ID}^{SL - PRS} mod 1024 ) + 1 ) \\ + ( {n}_{ID}^{S L - PRS} mod 1024 ) ) mod {2}^{31}\end{matrix}$$

For generating an SL-PRS sequence ID

$${n}_{ID}^{SL - PRS}$$

configuration, one or multiple option(s) may be supported. The options may include: (1) SL-PRS sequence ID is a higher layer configured parameter; (2) SL-PRS sequence ID is associated with CRC for the SCI associated with SL-PRS; (3) SL-PRS sequence ID is associated with UE ID information. If the SL-PRS sequence ID is a higher layer configured parameter, the SL-PRS sequence ID may be configured per SL-PRS resource in a resource pool configuration. For example, the SL-PRS sequence ID can be either configured for each SL-PRS resource, configured for multiple SL-PRS resources, or configured for each SL-PRS resource set. Alternatively, SL-PRS sequence ID can be configured per UE. The sequence ID related information can be either preconfigured in resource pool for UEs or additionally carried in SCI. Sequence ID indicated in SCI is a subset of sequence IDs (pre-) configured in higher layer. For example, the value range of SL-PRS sequence ID is 0-4095. If higher layer (LMF via LPP, UE via SLPP, gNB via RRC) configures 4 SL-PRS sequence IDs, SCI may only use 2 bits to indicate which sequence ID is used among those 4 sequence IDs. By using this method, it can protect UE's privacy and increase the reliability.

If one SCI triggers/reserves/indicates one SL-PRS resource (e.g., referring to FIG. 7) and SL-PRS sequence ID is based on the 12 bits representation of CRC for the PSCCH associated with the SL-PRS, each SL-PRS resource 704 may be associated with one PSCCH 706.

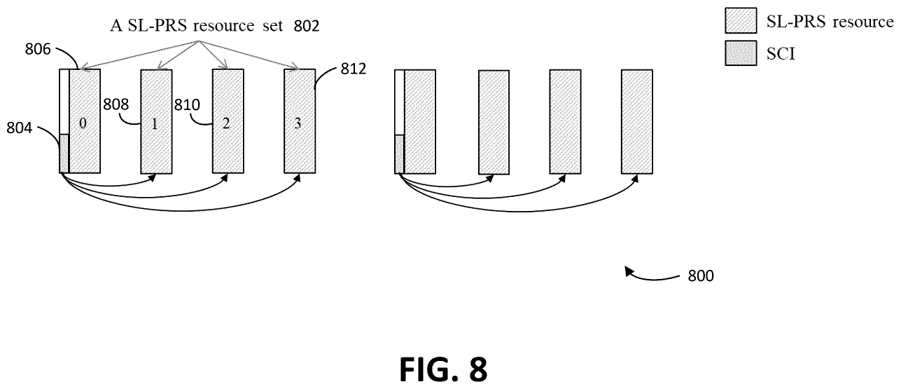

With reference to FIG. 8 (e.g., a diagram illustrating an example sidelink configuration 800, according to various arrangements), one SCI 804 may trigger/reserve/indicate an SL-PRS resource set 802 which consists of multiple SL-PRS resources (e.g., an SL-PRS resource set 802 consisting of 4 SL-PRS resources 806, 808, 810, and 812), or the SCI 804 may trigger/reserve/indicate more than one SL-PRS resources. Under such condition, if an SL-PRS sequence ID is based on the 12 bits representation of CRC for the PSCCH associated with the SL-PRS, different SL-PRS resources 806, 808, 810, and 812 may be triggered by the same SCI 804 sharing the same sequence ID. To ensure that different SL-PRS resources 806, 808, 810, and 812 share different SL-PRS sequence ID, the SCI 804 may indicate the ID offset to make sure that each SL-PRS resource has a unique sequence ID (e.g., different SL-PRS resources reserved by a SCI use a different sequence ID offset).

For example, if the sequence ID is n, based on the SCI 804 which is associated with the SL-PRS transmission, then the sequence ID of SL-PRS resource 806 is “n+offset0”, the sequence ID of SL-PRS resource 808 is “n+offset1”, the sequence ID of SL-PRS resource 810 is “n+offset2”, and the sequence ID of SL-PRS resource 812 is “n+offset3”. If m+offset>4095, then (m+offset) mod 212 may be used. Alternatively, higher layer signaling (e.g. RRC, SLPP, LPP) can be used to indicate a sequence ID offset for each SL-PRS resource. The final SL-PRS sequence ID may be based on respective CRCs for both PSCCH and an ID offset indicated by higher layer, which may result in increased privacy for UEs. The techniques described herein may ensure that different SL-PRS resourced share different SL-PRS sequence IDs, and thus increase interference randomization and sequence correlation properties among SL-PRS resources of multiple UEs.

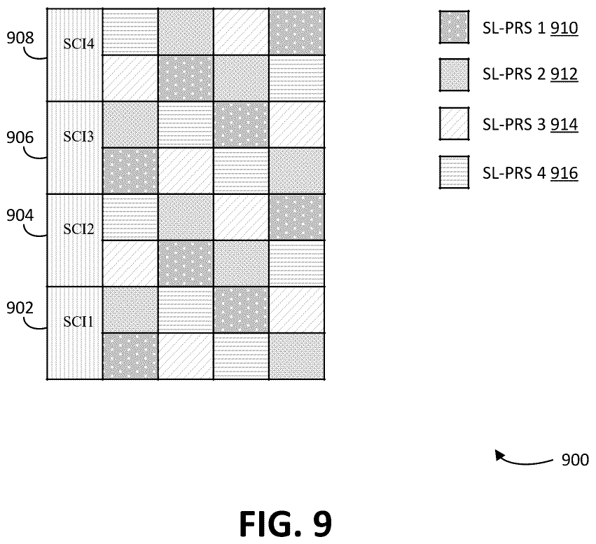

FIG. 9 is a diagram illustrating an example sidelink configuration 900, according to various arrangements. The sidelink configuration 900 may include SCIs 902, 904, 906, and 908, as well as a pattern of various resources, including SL-PRSs 910, 912, 914, and 916.

In some cases, the configuration 900 may support congestion control for SL positioning. Congestion control mechanisms for SL-PRS can be introduced that support SL positioning (e.g., SL-PRS resource allocation scheme2) quality of service (QoS). For example, during UE SL-PRS resource selection procedure, a UE can measure an SL-PRS channel busy ratio (CBR). Combining the CBR measurement result and the SL-PRS transmission priority, the corresponding transmission parameter for SL-PRS can be further determined or adjusted. SL positioning QoS parameter may include horizontal accuracy, vertical accuracy, vertical request, response time, accuracy regarding distance or direction, SL-PRS priority, selection window size of SL-PRS resource allocation scheme 2, retransmission time, minimum required communication range, congestion control parameters. The QoS parameters can be either QoS requirements sent to UE from gNB via RRC, LMF via LPP or another UE via SLPP (e.g. server UE), or QoS parameters for a sidelink positioning QoS flow. A UE can transmit QoS parameters for a sidelink positioning QoS flow to another UE or to gNB or to LMF.

In some cases, a SL-PRS CBR may be described. SL-PRS congestion control (e.g., a congestion control parameter) may help to adjust/determine SL-PRS transmission parameter(s) according to the channel busyness and the priority of an SL-PRS transmission. For example, both SL-PRS channel occupancy ratio (CR) and SL-PRS CBR are parameters for congestion control, where the SL-PRS CBR may define the channel busy ratio (e.g., based on reference signal received power (RSRP), received signal strength indicator (RSSI)) within a configured (preconfigured) time window, and the SL-PRS CR may define the channel occupancy ratio of one SL-PRS transmission. If a UE is configured with higher layer parameter indicating CRSL-PRS, Limit and transmits SL-PRS, the UE may ensure various limits for any priority value k of SL-PRS (the lower the priority value k, the higher the priority) according to:

$${\sum }_{i \geq k} {CR}_{SL - PRS} ( i ) \leq {CR}_{SL - PRS , Limit} ( k )$$

Where CRSL-PRS (i) is the CR evaluated within a time window/period for SL-PRS transmission with priority i (e.g., the priority can be indicated in SCI) and CRSL-PRS, Limit (k) corresponds to the higher layer parameter that is associated with the priority k and the CBR range which includes the SL-PRS CBR measured with another time window/period. For example, if a UE is configured with SL-PRS-CR-limit and transmits SL-PRS in slot n, the UE may ensure the various limits, where the CR is evaluated in slot n-N within a window (M1) and CBR is evaluated in slot n-N within a window (M2).

The definition of SL-PRS CBR for a dedicated SL-PRS resource pool can be different from that for a shared resource pool. Overall, regardless of dedicated resource pool or shared resource pool, an SCI is used to reserve/trigger/indicate SL-PRS resources. There may be relationships between the SCI and associated SL-PRS resource(s) (e.g., either one SCI resource/configuration is associated with one SL-PRS resource or one SCI is associated with more SL-PRS resources), and the SCI might be in a different time location (e.g. slot, symbol) than the SL-PRS. The SL-PRS CR and SL-PRS CBR may be based on either PSCCH/SCI or SL-PRS, or both PSCCH/SCI and SL-PRS, where the PSCCH/SCI is associated with SL-PRS transmission. In such a case, one or more of the following may be supported for SL positioning congestion control: CR for SL positioning is evaluated based on SL-PRS; CR for SL positioning is evaluated based on PSCCH/SCI, if each SL-PRS transmission is associated with SCI/PSCCH; CR for SL positioning is evaluated based on both PSCCH/SCI and SL-PRS (e.g., one or more of the following examples can be supported: the CR is the maximum CR between CR evaluated based on PSCCH/SCI and CR evaluated based on SL-PRS. Or the CR is the average or weighted average of CR evaluated based on PSCCH/SCI and CR evaluated based on SL-PRS. The weighted factor can be defined by higher layer signaling (e.g. this factor can be configured per SL-PRS resource pool via RRC signaling, or up to pre-configuration or configured via LPP signaling or via SLPP signaling). Or the CR is the minimum CR between CR evaluated based on PSCCH/SCI and CR evaluated based on SL-PRS.); CR for SL positioning is evaluated based on PSCCH/PSSCH if both SL-PRS, PSCCH and PSSCH are in the same resource pool; CBR for SL positioning is measured based on RSSI measurement of SL PRS; CBR for SL positioning is measured based on RSSI measurement of SCI/PSCCH; CBR for SL positioning is measured based on both RSSI measurement of SL PRS and that of SCI/PSCCH (e.g., one or more of the following examples can be supported: the CBR is the maximum CBR between CBR evaluated based on PSCCH/SCI and CBR evaluated based on SL-PRS. Or the CBR is the average or weighted average of CBR evaluated based on PSCCH/SCI and CBR evaluated based on SL-PRS. The weighted factor can be defined by higher layer signaling (e.g. this factor can be configured per SL-PRS resource pool via RRC signaling, or up to pre-configuration or configured via LPP signaling or via SLPP signaling). Or the CBR is the minimum CBR between CBR evaluated based on PSCCH/SCI and CBR evaluated based on SL-PRS.); and/or CBR for SL positioning is measured based on RSSI measurement of PSCCH/PSSCH.

For example, if PSCCH/SCI and SL-PRS has a one-to-one, one-to-many, or many-to-one mapping relationship and SL-PRS and its corresponding PSCCH/SCI are transmitted in a slot, measuring the channel busy ratio for PSCCH may be similar to measuring a channel busy ratio for SL-PRS. CR and CBR based on PSCCH/SCI may provide accuracy and reduce complexity over calculating the CR and CBR for both SL-PRS and PSCCH/SCI.

In some cases, a dedicated resource pool for SL-PRS may be supported. A definition for SL-PRS CBR and CR may be associated with SL-PRS resource allocation granularity and the SL-PRS resource configuration in a SL-PRS resource pool (e.g., SL-PRS CBR is associated with SL-PRS resource number and comb size). For example, if SL-PRS resource allocation time granularity is by slot and frequency granularity is by sub-channel, another method may include defining SL-PRS CR and SL-PRS CBR based on the occupancy/portion of a subchannel over multiple slots. If SL-PRS resource allocation granularity is by SL-PRS resource and sub-channel is not defined in a dedicated SL-PRS resource pool, defining SL-PRS CR or CBR based on sub-channel may result in difficulties. In an example, the definition of CR and CBR may be related to the SL-PRS resource configuration in a SL-PRS resource pool (e.g., related to whether the bandwidth and comb pattern of SL-PRS resources in a resource pool is the same or different). A mapping relationship between SL-PRS transmission parameter, SL-PRS CBR ranges, and SL-PRS transmission priority may be supported.

In a first embodiment, with reference to FIG. 9, a bandwidth and comb pattern of SL-PRS resources in one dedicated SL-PRS resource pool may be the same, and comb-based multiplexing of SL-PRS from different UEs may be applied.

If the bandwidth and comb pattern of SL-PRS resources in one dedicated SL-PRS resource pool are the same, and only comb-based multiplexing of SL-PRS from different UEs are allowed/supported in the dedicated SL-PRS resource pool, the definition and configuration of SL-PRS CR and SL-PRS CBR are associated with the number of occupied SL-PRS resource(s) and comb size. Alternatively, the definition and configuration of SL-PRS CR and SL-PRS CBR is associated with the number of occupied comb offset, SL-PRS sequence ID or the number of occupied PSCCH/SCI, or associated with both PSCCH/SCI and SL-PRS.

In some cases, for CR SL positioning for an evaluation time period/window, CR window size is up to higher layer (pre-) configuration. For example, CR time window size can be configured per SL-PRS resource pool via RRC signaling. CR time window size may also be configured for each SL-PRS resource or for each SL-PRS transmission priority or for each SL-PRS comb size. CR time window may also be configured by a UE via SLPP signaling or configured by an LMF via LPP signaling. The CR window size may also be related to the sensing window size and/or the selection window size of SL-PRS and/or SL-PRS periodicity, and/or SL-PRS resource reservation period. Or more specifically, CR window size may also be related to the maximum number of sensing window size and/or the maximum number of selection window size of SL-PRS.

In some cases, CR for SL positioning, the CR may be evaluated for each transmission, for each SL-PRS resource, or is associated with one SCI (e.g., if one SCI reserves one or more SL-PRS resource(s), then the CR is evaluated for one or more SL-PRS resource(s)).

In some cases, CR for SL positioning can be computed per SL-PRS priority level. For example, CR for positioning may be associated with the number of SL-PRS resources. CR for SL positioning can be defined as the total number of SL-PRS resources for its transmission (either used or expected) divided by the total number of configured SL-PRS resources in the transmission pool over a CR time window. CR for positioning may be associated with the number of SL-PRS resource's transmission occasions. The number of SL-PRS resources can be replaced by the number of SL-PRS resource occasion if one SL-PRS resource has repetition feature and thus one SL-PRS resource can have multiple transmission occasions. With reference to FIG. 9, the channel capacity may be related to SL-PRS comb size. The evaluation of CR may be associated with SL-PRS comb size. For example, if the comb size is 4, comb-based multiplexing may allow at most 4 UE multiplexing (supposing the number of symbols for the 4 SL-PRS resources 910, 912, 914, and 916 are the same). If comb size is 6, it is possible to allow multiplexing for 6 SL-PRS resources (not shown). If the number of symbols within a slot for a SL-PRS resource is flexibly configured, CR for SL positioning is also associated with the number of symbols for each SL-PRS resource.

In some cases, CBR for SL positioning may be supported. For an evaluation time period/window, a CBR window size is up to higher layer (pre-) configuration. For example, CBR time window size can be configured per SL-PRS resource pool via radio resource control (RRC) signaling. CBR time window size may also be configured for each SL-PRS resource, for each SL-PRS transmission priority, or for each SL-PRS comb size. CBR time window may also configured by UE via SLPP signaling or configured by LMF via LPP signaling.

The CBR window size may also be related to the sensing window size, the selection window size of SL-PRS, SL-PRS periodicity, and/or SL-PRS resource reservation period. The CBR window size may also be related to the maximum number of sensing window size and/or the maximum number of selection window size of SL-PRS.

In some cases, CBR for SL positioning may be associated with the portion of occupied SL-PRS resources whose signal strength (e.g., SL-PRS RSSI) is higher than a threshold. For example, SL-PRS RSSI can be defined as the linear average of the total received power (in W) observed in the configured SL-PRS resource in OFDM symbols of a slot. Correspondingly, SL-PRS CBR can be defined as the portion of SL-PRS resources in a SL-PRS resource pool whose SL-PRS RSSI measured by UE exceed a (pre-) configured threshold.

For another example, SL-PRS RSSI can be defined as the linear average of the total received power (in W) observed in the configured PSCCH resource in OFDM symbols of a slot. Correspondingly, SL-PRS CBR can be defined as the portion of PSCCH resources in a SL-PRS resource pool whose SL-PRS RSSI measured by UE exceeds a (pre-) configured threshold. With reference to FIG. 9, if SCI1 902, SCI2 904, SCI3 906, and SCI4 908 are busy and occupied, then the corresponding SL-PRS resource 910, SL-PRS resource 912, SL-PRS resource 914, and SL-PRS resource 916 may be occupied. Thus, the UE may experience difficulties transmitting SL-PRS in this resource pool (e.g., at least for this time). In some cases, the threshold of SL-PRS RSSI is up to higher layer (pre-) configuration.

In some cases, congestion control related SL-PRS transmission parameters may be supported. The congestion control related SL-PRS transmission parameters, and/or the mapping relationship between SL-PRS transmission parameters and CBR measurement/SL-PRS priority is up to higher layer (pre-) configuration. The higher layer signaling can be RRC signaling, MAC CE, SLPP between UE and UE, LPP signaling between LMF and UE. The determination of SL-PRS transmission parameters related to congestion control is associated with the definition of CR and CBR for SL positioning. In a first example, if the definition of CR, CBR for SL positioning is associated with the number of SL-PRS resource, the SL-PRS transmission parameters should include the indication of SL-PRS resource including the comb offset. In a second example, if the definition of CR, CBR for SL positioning is associated with the comb size of SL-PRS resource, the SL-PRS transmission parameters should include the indication of SL-PRS comb size. In a third example, if the definition of CR, CBR for SL positioning is associated with PSCCH, the SL-PRS transmission parameters should include the indication of PSCCH resource. In a fourth example, if the definition of CR, CBR for SL positioning is associated with SL-PRS sequence ID, the SL-PRS transmission parameters should include the indication of SL-PRS sequence ID. In a fifth example, the SL-PRS transmission parameters include maximum transmission power of SL-PRS.

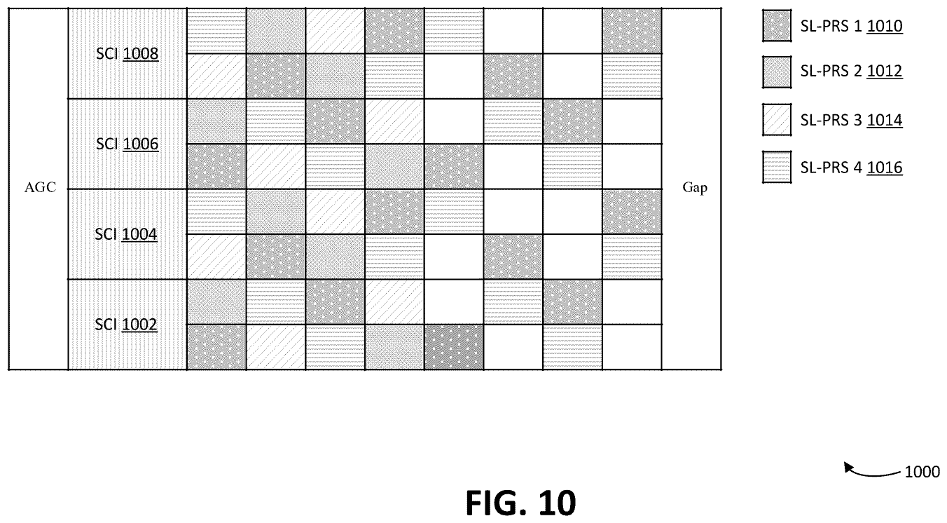

FIG. 10 is a diagram illustrating an example sidelink configuration 1000, according to various arrangements. The configuration 1000 may include various SCIs 1002, 1004, 1006, and 1008 and various SL-PRSs 1010, 1012, 1014, and 1016.

In a second embodiment, SL-PRS resources with a same bandwidth/comb size, but different symbol numbers are multiplexed. The slot of FIG. 10 may support room/capacity for 2 SL-PRS resources with comb size 4 and symbol number 4. Therefore, for accurately measuring the channel busy condition, the definition of CR/CBR for SL positioning may be accurate to symbol level and/or resource level.

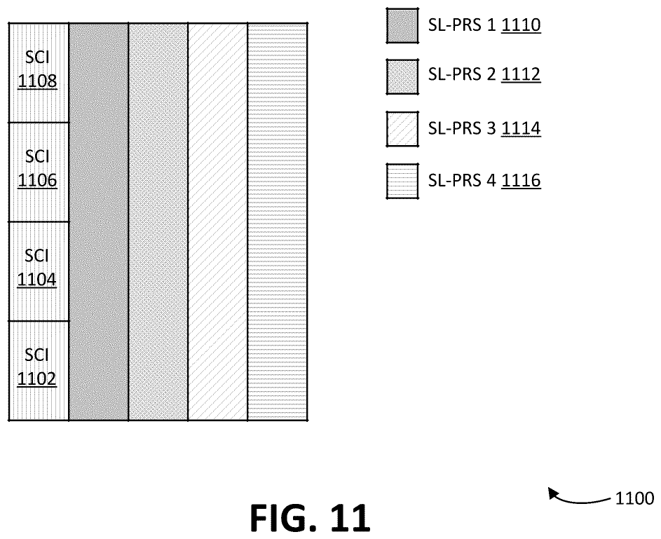

FIG. 11 is a diagram illustrating an example sidelink configuration 1100, according to some arrangements. The configuration 1100 may include various SCIs 1102, 1104, 1106, and 1108, as well as various SL-PRSs 1110, 1112, 1114, and 1116.

In a third embodiment, the bandwidth and comb pattern of SL-PRS resources in one dedicated SL-PRS resource pool may be the same (e.g., TDM-based multiplexing of SL-PRS from different UEs). If the bandwidth and comb pattern of SL-PRS resources in one dedicated SL-PRS resource pool are the same, and only TDM-based multiplexing of SL-PRS from different UEs are allowed/supported in the dedicated SL-PRS resource pool, the definition and configuration of SL-PRS CR and SL-PRS CBR is associated with the number of occupied SL-PRS resource(s) and the number of symbols for each SL-PRS resource.

Or the definition and configuration of SL-PRS CR and SL-PRS CBR is associated with the number of occupied PSCCH resource(s), or the definition and configuration of SL-PRS CR and SL-PRS CBR is either associated with both the number of occupied PSCCH resource(s) and the corresponding reserved SL-PRS resource or the definition and configuration of SL-PRS CR and SL-PRS CBR is associated with the number of occupied comb offset or SL-PRS sequence ID.

In some examples, CR for SL positioning is evaluated for each transmission, or for each SL-PRS resource, or CR for positioning is associated with one SCI (e.g., if one SCI reserves one or more SL-PRS resource(s), CR is evaluated for one or more SL-PRS resource(s)). In some examples, CR for SL positioning can be computed per SL-PRS priority level.

In some examples, CR for positioning is associated with the number of SL-PRS resources. In a first example, CR for SL positioning can be defined as the total number of SL-PRS resources for its transmission (either used or expected) divided by the total number of configured SL-PRS resources in the transmission pool over a CR time window. In a second example, CR for positioning is also associated with the number of SL-PRS resource's transmission occasions. The number of SL-PRS resources can be replaced by the number of SL-PRS resource occasion if one SL-PRS resource has repetition feature and thus one SL-PRS resource can have multiple transmission occasions. For either example, as shown in FIG. 11, the channel capacity is closely related to SL-PRS symbol number within a slot and the evaluation of CR is associated with a number of symbols of SL-PRS resource. For example, if the symbol number is 2, TDM-based multiplexing will allow 4 UE multiplexing. On the other hand, if symbol number is 8, it is only possible to allow 1 SL-PRS resource (e.g., either SL-PRS 1110, 1112, 1114, or 1116) in a slot. For example, SL-PRS CR evaluated at slot n is defined as the total number of symbols used for its transmissions in slots [n-a, n-1] and granted in slots [n, n+b] divided by the total number of configured symbols in the SL-PRS transmission configuration over [n-a, n+b].

In some cases, CBR for SL positioning is supported. CBR for SL positioning may be associated with the portion of occupied SL-PRS resources whose signal strength is higher than a threshold. In a first example, SL-PRS RSSI can be defined as the linear average of the total received power (in W) observed in the configured SL-PRS resource in OFDM symbols of a slot. Correspondingly, SL-PRS CBR can be defined as the portion of SL-PRS resources in a SL-PRS resource pool whose SL-PRS RSSI measured by UE exceed a (pre-) configured threshold.

In a second example, SL-PRS RSSI can be defined as the linear average of the total received power (in W) observed in the configured PSCCH resource in OFDM symbols of a slot. Correspondingly, SL-PRS CBR can be defined as the portion of PSCCH resources in a SL-PRS resource pool whose SL-PRS RSSI measured by UE exceed a (pre-) configured threshold. As shown in FIG. 11, if SCI1 1102, SCI2 1104, SCI3 1106, and SCI4 1108 are busy and occupied, then the corresponding SL-PRS resource 1110, SL-PRS resource 1112, SL-PRS resource 1114, and SL-PRS resource 1116 are occupied and the UE may experience difficulties in transmitting SL-PRS in this resource pool (e.g., at least for this time). In some cases, the threshold of SL-PRS RSSI is up to higher layer (pre-) configuration.

In some cases, SL-PRS transmission parameters related to congestion control is associated with one of SL-PRS resource configuration (e.g., number of symbols) or maximum transmission power of SL-PRS.

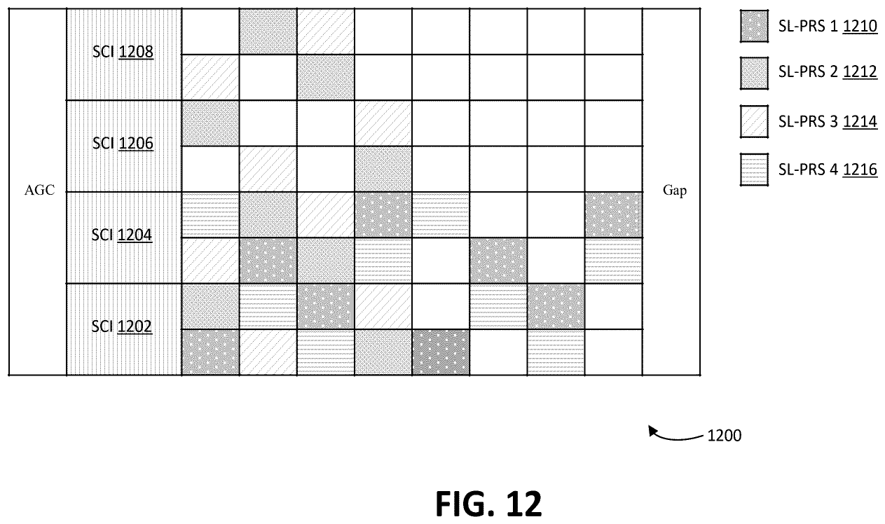

FIG. 12 is a diagram illustrating an example sidelink configuration 1200, according to various arrangements. The configuration 1200 may include various SCIs 1202, 1204, 1206, and 1208, as well as various SL-PRSs 1210, 1212, 1214, and 1216. The configuration 1200 may support SL-PRS resources multiplexing with different bandwidth and symbol numbers.

In a third embodiment, flexible configuration and resource indication of bandwidth and comb size associated with an SL-PRS is supported. If the SL-PRS bandwidth and comb size is flexibly configured in a SL-PRS resource pool, or if there is only one comb size and bandwidth in a SL-PRS resource pool, SCI can be used to indicate a bandwidth different from what is defined in the SL-PRS resource pool.

In a first example, the definition and configuration of SL-PRS CR and SL-PRS CBR may be associated with both the frequency domain pattern (e.g., number of busy/occupied RE) and time domain pattern (e.g., number of busy/occupied symbol) of SL-PRS resource. For example, the SL-PRS CR and/or CBR can be defined per comb size. For example, if one UE need to transmit two SL-PRS resources (one with comb size 2 and one with comb size 4), UE can measure the CBR separately for both comb size 2 and comb size 4. In some cases, SL-PRS resource with comb size 2 cannot be transmitted due to the busy channel but SL-PRS resource with comb size 4 can be transmitted.

In a second example, the definition and configuration of SL-PRS CR and SL-PRS CBR is associated with PSCCH, or the definition and configuration of SL-PRS CR and SL-PRS CBR is associated with both PSCCH and the corresponding SL-PRS resource. For example, CR for SL positioning can be defined as the total number of REs for its transmission (either used or expected) divided by the total number of configured REs in the transmission pool over a CR time window.

In some cases, a shared resource pool may be supported. The design for SL-PRS in shared resource pool should ensure backward compatibility. For RSSI, either a new SL-PRS RSSI is introduced or existing SL RSSI is reused with slight modification. For example, for a new SL-PRS RSSI, the SL-PRS RSSI may be defined as the linear average of the total received power (in W) observed in the configured sub-channel in OFDM symbols of a slot configured for SL-PRS, starting from the 2nd OFDM symbol. Or the SL-PRS RSSI is defined as the linear average of the total received power (in W) observed in the configured sub-channel in OFDM symbols of a slot configured for PSCCH and SL-PRS, starting from the 2nd OFDM symbol. For an SL RSSI with modification, the SL RSSI is defined as the linear average of the total received power (in [W]) observed in the configured sub-channel in OFDM symbols of a slot configured for PSCCH and PSSCH or SL-PRS, starting from the 2nd OFDM symbol.

The CR or CBR window size may also be related to the sensing window size, the selection window size of SL-PRS, SL-PRS periodicity, and/or SL-PRS resource reservation period. For example, CR or CBR window size may also be related to the maximum number of sensing window size and/or the maximum number of selection window size of SL-PRS. The CR and CBR window size can be different from that of SL communication. Additionally, even if in shared resource pool, PSSCH and SL-PRS are transmitted within a slot, the priority of SL-PRS and that of PSSCH can be different. In such case, the CR can be evaluated separately for SL-PRS and PSSCH.

In some cases, congestion control processing time for SL-PRS is supported. For example, SL-PRS congestion control processing time is based on both subcarrier spacing (SCS) and UE capability, where SCS corresponds to the subcarrier spacing of the sidelink channel with which the SL-PRS is to be transmitted. The SL-PRS congestion control may also be associated with CR or CBR window size (e.g., N) for SL positioning. A UE may report one or more of its SL-PRS congestion control processing capability to a UE (SLPP signaling), LMF (LPP signaling), or gNB (RRC signaling). UE, LMF, or gNB (e.g., base station) may also request one UE to report its capability on SL-PRS congestion control processing capability.

Alternatively, if the CR or CBR window size is the same as that of SL communication or for shared resource pool, UE may use the same congestion control processing time for processing timing capability 1 or processing timing capability 2. A UE may report whether the congestion control processing capability is applicable for either SL communication or SL positioning, or both SL communication and SL positioning.

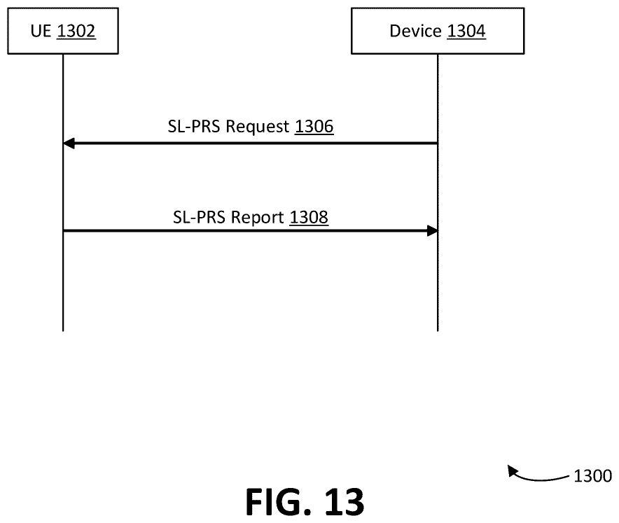

FIG. 13 is a diagram illustrating an example wireless communication 1300, according to various arrangements. The wireless communication 1300 may include a UE 1302 and a device 1304 (e.g., a server UE, a base station). The device 1304 may transmit, to the UE 1302, a request 1306 (e.g., an SL-PRS CBR measurements request), and the UE 1302 may transmit, to the device 1304, a report 1308 (e.g., an SL-PRS CBR measurements report).

For example, in SL positioning, for better congestion control (e.g., adjust the SL-PRS resource pool configuration, adjust SL-PRS resource configuration), UE can report the SL-PRS CBR measurements to gNB or other UEs or LMF. A UE may report its CBR measurements to one or more UEs, a UE may request one or more UE to provide CBR measurement for SL positioning.

For the SL-PRS CBR measurements request 1306, device 1304 may send signaling (e.g. RRC, MAC CE, DCI, LPP, via higher layer signaling, SLPP, PC5-RRC, PC5-S, application layer) to the UE 1302 to request CBR measurements. The request signaling may include at least one of the following: SL-PRS resource pool ID, SL-PRS CBR measurements, time stamp of CBR measurement, time window of CBR measurement, comb size, SL-PRS resource ID, SL-PRS resource set ID, CBR of SL-PRS or CBR of SCI or CBR for both SL-PRS and SCI, CBR measurements for a certain comb size, and/or expected time window.

For the SL-PRS CBR measurements report 1308, the UE 1302 may report SL-PRS CBR measurements to the device 1304 (e.g., via higher layer signaling, SLPP, PC5-RRC, PC5-S, application layer, RRC, MAC CE, DCI, LPP). The report signaling may include at least one of the following: SL-PRS resource pool ID, SL-PRS CBR measurements, time stamp of CBR measurement, time window of CBR measurement, comb size, SL-PRS resource ID, SL-PRS resource set ID, CBR of SL-PRS or CBR of SCI or CBR for both SL-PRS and SCI, and/or CBR measurements for a certain comb size. Additionally, the UE 1302 may report its capability to UE or gNB or LMF on whether it supports SL-PRS CBR measurements.

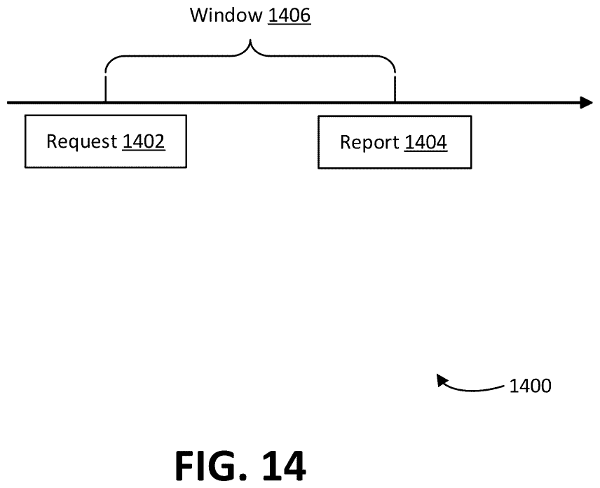

FIG. 14 is a flowchart diagram illustrating an example wireless communication 1400, according to various arrangements. The communication 1400 may be related to latency. The CBR measurement request 1402 and corresponding CBR report 1404 should be finished within an expected time window 1406. The time requirement/latency can either be contained in each CBR measurement request, or can be (pre-) configured via higher layer signaling between UEs (e.g. SLPP) or between UE and gNB/LMF (e.g. RRC, LPP).

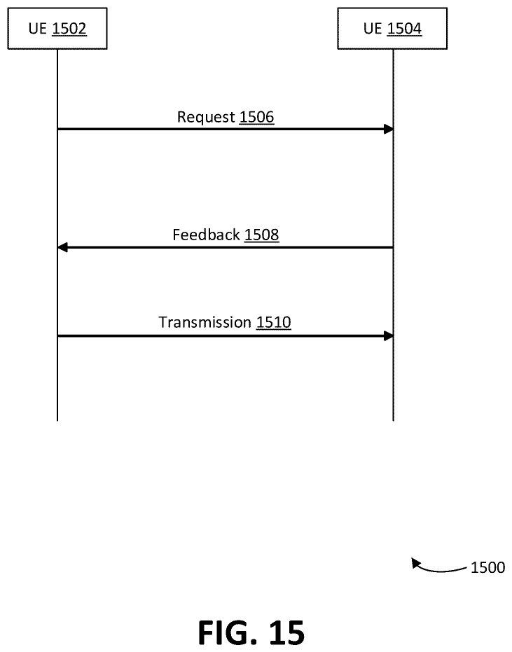

FIG. 15 is a flowchart diagram illustrating an example wireless communication 1500, according to various arrangements. The wireless communication 1500 may include a UE 1502 and a UE 1504. The UE 1502 may transmit, to the UE 1504, a request 1506 (e.g., a request for CBR results of a Tx SL-PRS resource pool); the UE 1504 may transmit, to the UE 1502, feedback 1508 (e.g., CBR results feedback); and the UE 1502 may transmit, to the UE 1504, a transmission 1510 (e.g., an SL-PRS transmission according to the CBR results).

For example, in a scenario where there are multiple anchor UEs and one target UE involved in a positioning session or involved in a positioning of the target UE, if the target UE provides SL-PRS resource transmission information to multiple anchor UEs, then the anchor UEs may save energy. In such a case, a UE may calculate the SL-PRS CBR for one or more UEs. The UE may assist SL-PRS transmissions of other UE(s) by conducting CBR measurement for the other UE(s). The CBR calculation for another UE can be triggered by a request of the UE, triggered by higher layer signaling of gNB, or triggered by higher layer of the UE.

The techniques described herein may support one or more of the following procedures. UE 1502 can request another UE 1504 to calculate CBR measurements for UE 1502. The request signaling 1506 may include whether CBR assist is required, SL-PRS resource pool information for CBR, SL-PRS resource(s) of UE 1502 to be transmitted, CBR of SL-PRS or CBR of SCI or CBR for both SL-PRS and SCI, CBR measurements for a certain comb size, and/or responding time requirement. UE 1504 may send the feedback 1508 to UE 1502 responding to the request 1506. The feedback 1508 may include: CBR measurement, SL-PRS resource pool information, CBR of SL-PRS or CBR of SCI or CBR for both SL-PRS and SCI, CBR measurement per comb pattern, and/or CBR measurement failure. Once UE 1502 receives the CBR measurements measured by UE 1504, UE 1502 transmits SL-PRS and defines the corresponding SL-PRS transmission parameters based on CBR provided by UE 1504.

In some cases related to latency, the assisting CBR measurement request and corresponding CBR response should be finished within a time window. The time requirement can be contained in each CBR measurement request or can be (pre-) configured via higher layer signaling between UEs or between UE and gNB/LMF. Moreover, the UE may report capability to UE or gNB or LMF on whether it supports assisting CBR measurements of other UEs. A UE may also report its capability to UE or gNB or LMF on whether it support receiving CBR measurements of other UEs.

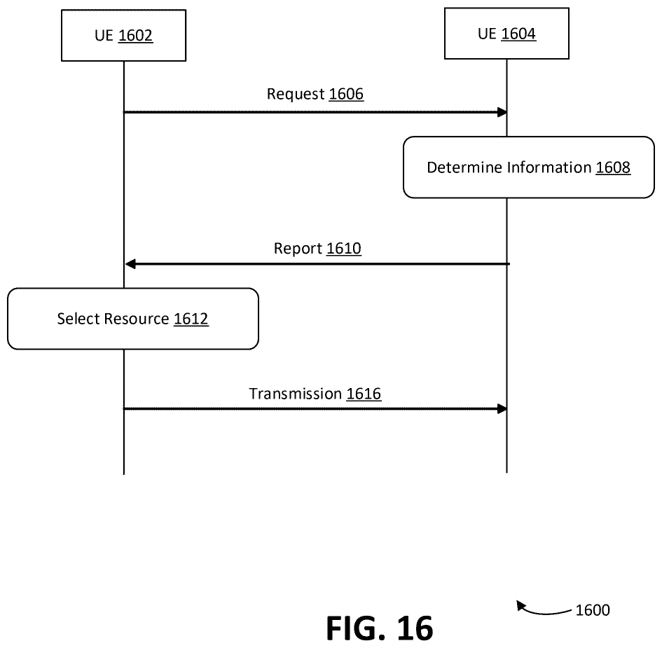

FIG. 16 is a flowchart diagram illustrating an example wireless communication 1600, according to various arrangements. The communication 1600 may include a UE 1602 and a UE 1604 in sidelink communication.

For UE autonomous SL-PRS resource allocation, IUC information transfer for sidelink positioning among a number of UEs may result in various advantages for maximum resource utilization and minimum resource conflicts. In SL communication, the UE 1602 may request SL-PRS IUC, at 1606. At 1608, UE 1604 can determine one or more resource conflict (IUC scheme2) or determine whether a set of resources are recommended (IUC scheme1) for an SL-PRS transmission for UE-1602. At 1610, the UE 1604 can report the SL-PRS IUC information to the UE 1602. At 1612, the UE 1602 can select (reselect) an SL-PRS resource based on the SL-PRS IUC information for sidelink positioning before transmitting an SL-PRS transmission at 1616.

In some cases, usage of IUC in SL positioning may include indicating whether a set of SL-PRS resources are preferred or non-preferred; indicating the potential/expected/detected resource conflict; and/or an IUC frame being used for allocating SL-PRS resources or deliver SL-PRS configurations/resource allocation among UEs, where one UE may reserve the SL-PRS resource for another UE. For example, UE 1602 can request UE 1604 to allocate or reserve SL-PRS resource(s). UE 1604 may further reserve or allocate corresponding SL-PRS resource(s) and deliver this information to UE 1602. The latency bound/time requirement of SL-PRS IUC report from the associated SL-PRS IUC explicit request triggering may be (pre-) defined/configured by network in RRC layer or MAC layer, or by UE via SLPP, SCI, SL MAC CE, PC5-RRC layer, PC5-S layer or by LMF via LPP signaling.

In some cases, SL-PRS IUC signaling may be supported. For example, for SL-PRS IUC for recommendation (preferred/non-preferred), an IUC trigger and/or an IUC report may be supported. In a first example, SL-PRS IUC can be triggered by explicit request from a UE or triggered by a condition, the container of an explicit request can be SCI, MAC CE or both SCI and MAC CE, SLPP, LPP, RRC. The IUC request may include an extra bit indicating the requested IUC information is generated based on SCI or SL-PRS, or both SCI and SL-PRS. In detail, UE 1602 can request UE 1604 for IUC information regarding whether the preferred/non-preferred resource is obtained based on PSCCH's occupancy or SL-PRS's occupancy, or based on both PSCCH and SL-PRS's occupancy. One or more of the following parameters/information may also be included in IUC request signaling: SL communication or SL-PRS IUC indicator (e.g., 1 bit), providing or requesting indicator (e.g., 1 bit), preferred or non-preferred resource (1 bit), the location of selection window, priority of SL-PRS transmission, SL-PRS resource ID, SL-PRS resource set ID, SL-PRS resource reservation period or SL-PRS periodicity, comb size, SL-PRS bandwidth, and/or SL-PRS sequence ID.

In a second example, the container of SL-PRS IUC report (e.g., UE 1604 report IUC to UE 1602) can be SCI, MAC CE or both SCI and MAC CE, SLPP, LPP, RRC. The IUC report may include an extra bit indicating the IUC information is generated based on SCI or SL-PRS. In detail, UE 1604 can inform UE 1602 that the preferred/non-preferred resource is obtained based on PSCCH's occupancy, SL-PRS's occupancy, or based on both PSCCH and SL-PRS's occupancy. One or more of the following parameters/information may also be included in IUC report signaling: SL communication or SL-PRS IUC indicator (e.g., 1 bit), providing or requesting indicator (e.g., 1 bit), preferred or non-preferred resource (1 bit), one or a list of preferred/non-preferred SL-PRS resource(s), the first resource location for each preferred/non-preferred SL-PRS resource, SL-PRS periodicity, comb size, SL-PRS bandwidth, and/or SL-PRS sequence ID.

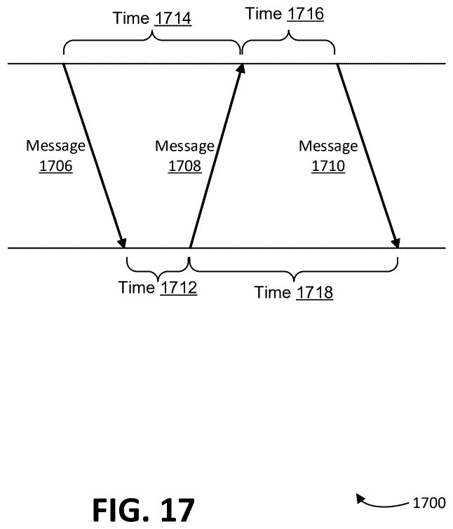

FIG. 17 is a flowchart diagram illustrating an example wireless communication 1700, according to various arrangements. The communication 1700 may include a UE 1702 and a UE 1704 in sidelink communication. Time 1712 may be time to reply to message 1706 after reception, time 1714 may be RTT from sending message 1706 to receiving message 1708, time 1716 may be time to transmit message 1710 upon receiving message 1708, and time 1718 may be RTT from sending the message 1708 to receiving the message 1710.

The communication 1700 may support a combination of SL-PRS IUC with different positioning methods. For SL-RTT (e.g., double side RTT), SL-PRS IUC information contained in SCI or SL MAC CE can be transmitted along with SL-PRS 1 transmission (e.g., message 1706). The IUC information may include preferred or non-preferred resources or include reserved/allocated SL-PRS resources for SL-PRS 2 transmission (e.g., message 1708). This may initiate the transmission of RTT positioning and assist transmission by the UE 1704.

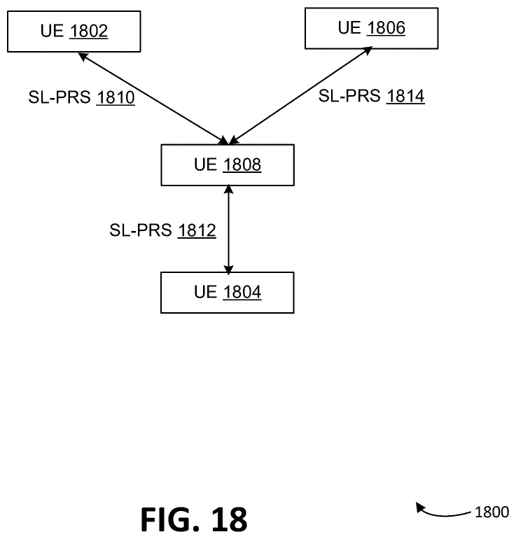

FIG. 18 is a flowchart diagram illustrating an example wireless communications system 1800, according to various arrangements. The system 1800 may include a UE 1802, a UE 1804, a UE 1806, and a UE 1808 in sidelink communication (e.g., SL-TDOA). Each of the UEs 1802, 1804, and 1806 may communicate respective SL-PRSs 1810, 1812, and 1814 with the UE 1808. For example, UE 1808 (e.g., a target UE) may receive SL-PRS from three anchor UEs 1802, 1804, and 1806, where anchor UE 1802 transmits SL-PRS 1810, anchor UE 1804 transmits SL-PRS 1812, and anchor UE 1806 transmits SL-PRS 1814. From the perspective of the target UE 1808, the UE 1808 may arrange measurement of SL-PRS by target UE 1808 transmitting SL-PRS IUC to the multiple anchor UEs 1802, 1804, and 1806.

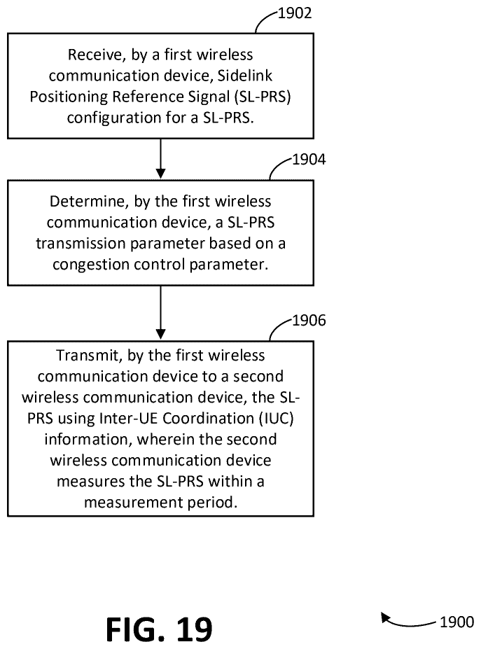

FIG. 19 is a flowchart diagram illustrating an example method 1900 for sidelink positioning enhancement, according to various arrangements. In some cases, the method 1900 may include configurations for a wireless communication device to receive SL-PRS configuration.

At 1902, a first wireless communication device may receive an SL-PRS configuration for an SL-PRS. At 1904, the first wireless communication device may determine an SL-PRS transmission parameter based on a congestion control parameter. At 1906, the first wireless communication device may transmit, to a second wireless communication device, the SL-PRS using IUC information, wherein the second wireless communication device measures the SL-PRS within a measurement period.

For example, SL positioning measurement periods may be supported. When a physical layer receives the last of a NR-ProvideAssistanceData message and a NR-RequestLocationInformation message from a first UE via SLPP, a second UE may be able to measure multiple (up to the UE capability) UE SL-PRS RSTD/RSRP/RSRPP/Rx-Tx time difference measurements in configured resource pools within the measurement period.

A measurement period requirement for DL-PRS may be defined on a basis of positioning frequency layer (PFL) where each PFL is configured with SCS, CP, DL-PRS bandwidth, etc. UE may be unable to process/measure DL-PRS from different PFLs at the same time. However, a carrier may include only one BWP in SL communication. For example, SL SCS and CP is configured per SL BWP such that all resource pools in a single BWP of a carrier share the same SCS. Therefore, it is feasible for UE to process and measure SL-PRS resources from multiple Tx resource pools at the same time if multiple resource pools are from the same BWP. Measurement period requirement for SL-PRS can be defined on a basis of SL BWP. As shown below:

$${T}_{Total} = {\sum }_{i = 1}^{L} {T}_{i} + ( L - 1 ) * max ( {T}_{effect , i} )$$

where i is the index of SL-BWP and L is total number of SL-BWPs if SL CA (carrier aggregation) is introduced and there are one or more SL BWP(s).

Because there is only one SL BWP, L=1:

$${T}_{Total} = {\sum }_{i = 1}^{L} {T}_{i} + ( L - 1 ) * max ( {T}_{effe ct , i} ) = {T}_{1}$$

The measurement period requirement for SL positioning is associated with one or more of the following: the maximum resource reservation time indicated in SCI 1-A (e.g. 32 slots); sensing window size for SL positioning; selection window size for SL positioning; other latency related parameter; SL-PRS CBR, CR, CRlimt; SL-PRS transmission priority; SL-PRS periodicity or SL-PRS resource reservation period indicated in SCI (e.g., if different SL-PRS resources have different periodicity, the measurement period requirement is associated with the least common multiple (LCM) of multiple SL-PRS periodicities); sample number: 1,2,4 or other values; (N, T) for SL-PRS (e.g., the duration N of SL-PRS symbols in units of ms/slot/symbol a UE can process every T ms/slot/symbol, where (N,T) for SL-PRS is a UE capability and the measurement period requirement can be defined based on the capability); maximum number of SL-PRS resources in a slot; TEG related scaling factor; beam sweeping factor; and whether double-sided RTT (DS-RTT) method is used. For example, if double-sided RTT is used, compared with the measurement period requirement defined for single-sided RTT (SS-RTT), the measurement period requirement for double-sided RTT is larger with an extra offset added or multiply a scaling factor based on the equation for single-sided RTT.

In some cases, for DS-RTT, an offset A can be introduced for the equation of measurement period for DS-RTT compared to that for SS-RTT, A≥0:

$${T}_{DS - RTT , Total} = {T}_{SS - RTT , Total} + Δ$$

Or a scaling factor S can be introduced with S≥1 or S>1:

$${T}_{DS - RTT , Total} = S * {T}_{SS - RTT , Total}$$

Introducing an offset or scaling factor for DS-RTT can capture that the complexity and latency of UE measuring DL-PRS for DS-RTT method is larger than the complexity and latency of UE measuring DL-PRS for SS-RTT method.

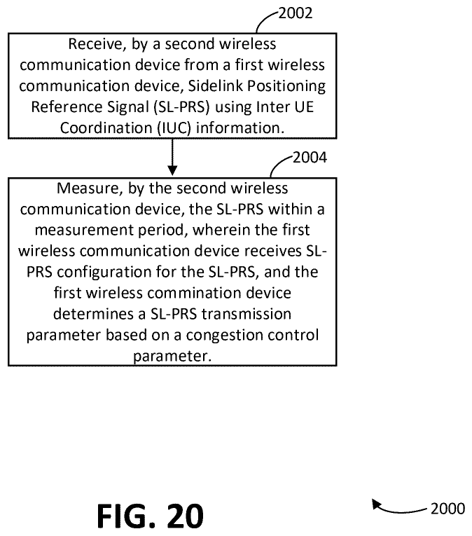

FIG. 20 is a flowchart diagram illustrating an example method 2000 for sidelink positioning enhancement, according to various arrangements. In some cases, the method 2000 may include configurations for a wireless communication device to receive an SL-PRS.

At 2002, a second wireless communication device may receive, from a first wireless communication device, an SL-PRS using IUC information. At 2004, the second wireless communication device may measure the SL-PRS within a measurement period, wherein the first wireless communication device receives an SL-PRS configuration for the SL-PRS, and the first wireless commination device determines a SL-PRS transmission parameter based on a congestion control parameter.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
receiving, by a first wireless communication device, a Sidelink Positioning Reference Signal (SL-PRS) configuration for a SL-PRS; and
determining, by the first wireless communication device, a SL-PRS transmission parameter based on a congestion control parameter.

2. The wireless communication method of claim 1, wherein the SL-PRS configuration corresponds to a resource pool for the SL-PRS.

3. The wireless communication method of claim 2, wherein the resource pool comprises one of:
comb-based multiplexed resources for a plurality of wireless communication devices;
Time-Division Multiplexed (TDM) resources for the plurality of wireless communication devices; or
a combination of comb-based multiplexed resources and the TDM resources for the plurality of wireless communication devices.

4. The wireless communication method of claim 2, wherein the resource pool comprises at least the SL-PRS configuration and a Physical Sidelink Control Channel (PSCCH) configuration.

5. The wireless communication method of claim 2, wherein
the resource pool comprises at least one of:
at least one SL-PRS resource; or
at least one SL-PRS resource set;
each of the at least one SL-PRS resource or each of the at least one SL-PRS resource set is associated with a Physical Sidelink Control Channel (PSCCH) configuration or a Sidelink Control Information (SCI) configuration.

6. The wireless communication method of claim 2, wherein
the resource pool comprises at least one SL-PRS resource; and
the resource pool is associated with a Physical Sidelink Control Channel (PSCCH) configuration.

7. The wireless communication method of claim 2, wherein one of:
the resource pool is identified by a resource pool identifier (ID), and Sidelink Control Information (SCI) indicates the resource pool ID; or
the resource pool comprises a SL-PRS resource identified by a resource ID, and the SCI indicates the resource ID; or
the resource pool comprises a SL-PRS resource set identified by a resource set ID, and the SCI indicates the resource set ID.

8. The wireless communication method of claim 1, wherein an SL-PRS sequence ID offset is indicated by a Sidelink Control Information (SCI).

9. The wireless communication method of claim 1, wherein an SL-PRS sequence ID offset is indicated by a higher layer.

10. The wireless communication method of claim 1, wherein the congestion control parameter comprises at least one of a SL-PRS Channel occupancy Ratio (CR) or a SL-PRS Channel Busy Ratio (CBR).

11. The wireless communication method of claim 1, wherein the congestion control parameter is associated with at least one of Physical Sidelink Control Channel (PSCCH)/Sidelink Control Information (SCI) or the SL-PRS.

12. The wireless communication method of claim 1, wherein the congestion control parameter is defined based on a SL-PRS resource allocation granularity and the SL-PRS configuration for a resource pool for the SL-PRS.

13. The wireless communication method of claim 12, wherein at least one of:
the congestion control parameter is defined using a number of occupied resources for the SL-PRS and a comb size; or
the congestion control parameter is defined using a number of occupied comb offset, a sequence ID for the SL-PRS, a number of occupied Physical Sidelink Control Channel (PSCCH)/Sidelink Control Information (SCI), or both of the PSCCH/SCI and the SL-PRS.

14. The wireless communication method of claim 12, wherein
the congestion control parameter is associated with an evaluation time window; and
a size of the evaluation time window is preconfigured or configured by a higher layer.

15. The wireless communication method of claim 12, wherein at least one of:
the congestion control parameter is associated with at least one of one or more occupied resources for the SL-PRS, the at least one of the one or more occupied resources has a first signal strength higher than a first threshold; or
the congestion control parameter is associated with at least one Physical Sidelink Control Channel (PSCCH) resource in a resource pool for the SL-PRS, the at least one PSCCH resource has a second signal strength higher than a second threshold.

16. The wireless communication method of claim 12, wherein the congestion control parameter is defined using symbols or Resource Elements (REs).

17. The wireless communication method of claim 12, wherein at least one of:
the congestion control parameter is defined using a number of occupied resources for the SL-PRS and a number of time resources for each resource for the SL-PRS;
the congestion control parameter is defined using a number of occupied Physical Sidelink Control Channel (PSCCH) resources; or
the congestion control parameter is defined using a number of occupied PSCCH resources and a corresponding reserved SL-PRS resource.

18. The wireless communication method of claim 12, wherein
the congestion control parameter is defined using a frequency domain pattern and a time domain pattern; or
the congestion control parameter is defined for each comb size.

19. The wireless communication method of claim 1, wherein
the SL-PRS transmission parameter is defined using a window size for the congestion control parameter;
the wireless communication method further comprising reporting, by the first wireless communication device to the network or to a second wireless communication device, processing capability relating to the congestion control parameter.

20. A first wireless communication device, comprising:
at least one processor configured to:
receive, via a transceiver, a Sidelink Positioning Reference Signal (SL-PRS) configuration for a SL-PRS; and
determine a SL-PRS transmission parameter based on a congestion control parameter.
